(19) United States
(12) Patent Application Publication
(10) Pub. No.: US 2010/0123816 A1
(43) Pub. Date: May 20, 2010

(54) METHOD AND APPARATUS FOR GENERATING A THUMBNAIL OF A MOVING PICTURE

(75) Inventors: Sung-shik Koh, Suwon-si (KR); Kyoung-jae Kim, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/619,869

(22) Filed: Nov. 17, 2009

(30) Foreign Application Priority Data
Nov. 18, 2008 (KR) 10-2008-0114858

(51) Int. Cl. G06K 9/46; H04N 5/222

(52) U.S. Cl. 348/333.05; 382/195; 348/E05.022

(57) ABSTRACT

A system and associated method provide for generating a thumbnail of a moving picture, where the method includes detecting face areas from input frames, detecting a face feature from each of the input frames based on a detected face area, determining a predetermined characteristic based on the face area, determining candidate frames for generating a thumbnail image of the input frames, using a detected face feature and a determined characteristic, and generating one of the candidate frames meeting a set thumbnail image condition, as a thumbnail image.

### CROSS-REFERENCE TO RELATED PATENT APPLICATIONS

This application claims the benefit of Korean Patent Application No. 10-2008-0114858, filed on Nov. 18, 2008, in the Korean Intellectual Property Office, the disclosure of which is incorporated herein in its entirety by reference.

### BACKGROUND

The present invention relates to a method and apparatus for generating a thumbnail, and more particularly, to a method and apparatus for generating a thumbnail of a moving picture.

Technologies used to identify a moving picture taken using a digital still camera or a digital camcorder, with a thumbnail image only, have been developed. According to a conventional technology, to generate a thumbnail of a moving picture, an image of a frame selected at an appropriate timing, regardless of the content of the moving picture, is generated as a thumbnail image, or a thumbnail is extracted under the condition that a face area appearing in an image is over a predetermined size.

Japanese Laid-Open Patent Publication No. 2007-266655 discloses a technology to generate a thumbnail for a moving picture that appropriately shows the characteristic of the moving picture. According to this technology, a face area detection unit detects a face area of a person existing in a photographed image forming a moving picture. The detected face areas are selected as candidate groups and a thumbnail is generated from the candidate groups according to various thumbnail generation triggers.

However, the technology has a limit in reliably extracting a thumbnail in relation to face detection. In particular, since the generation of a thumbnail of a moving picture is determined based on the existence of a face and a face size only, the thumbnail is selected regardless of the expression of a face and there is no means to configure a thumbnail only for oneself (or for a predefined person). Also, there is no means to determine a person's smile and blink conditions. Since the conventional moving picture thumbnail generation technology uses a method of collectively applying a predetermine frame or in an inefficient detection method, the technology is not reliable.

### SUMMARY

To solve the above and/or other problems, various embodiments of the present invention provide a method and apparatus for generating a thumbnail of a moving picture by selecting a candidate group of frames based on the persons appearing on the moving picture using face detection, a smile detection, and a blink detection, and determining the best frame for oneself from the candidate group.

Embodiments of the present invention provide a computer readable recording medium having recorded thereon a program for executing the method.

Embodiments of the present invention provide a digital imaging apparatus including the moving picture thumbnail generation apparatus.

According to an aspect of the present invention, a method of generating a thumbnail of a moving picture includes detecting face areas from input frames, detecting a face feature from each of the input frames based on a detected face area, determining a predetermined characteristic based on the face area, determining candidate frames for generating a thumbnail image, of the input frames, using a detected face feature and a determined characteristic, and generating one of the candidate frames meeting a set thumbnail image condition, as a thumbnail image.

The face feature may include at least one of a smile, a blink, a face size, and a face position.

The characteristic may include at least one of identity verification, sex, and age.

In the determining of candidate frames, a parameter value according to the face feature and the characteristic may be calculated, and each of the candidate frames and a parameter value of the candidate frame may be stored.

The method further includes comparing the parameter value of the candidate frame with the set thumbnail image condition value, and controlling the generation of a candidate frame corresponding to a parameter value meeting the thumbnail image condition value as a thumbnail image, as a result of the comparison.

The method may further include setting a thumbnail image condition including at least one of a smile condition, a blink condition, a face size, a face position, identity verification, sex, and age.

A different added value may be given to each thumbnail image condition according to selection by a user.

Before the comparing of the parameter value of the candidate frame with the set thumbnail image condition value, the method may further include ending the photography of a moving picture according to selection by a user.

The determining of a predetermined characteristic based on the face area may be based on face recognition.

According to another aspect of the present invention, a computer readable recording medium is provided having recorded thereon a program for executing the method defined in the above method.

According to another aspect of the present invention, an apparatus for generating a thumbnail of a moving picture includes a face area detection unit for detecting a face area from input frames, a face feature detection unit for detecting a face feature from each of the input frames based on a detected face area, a characteristic determination unit for determining a predetermined characteristic based on the face area, a candidate frame determination unit for determining candidate frames for generating a thumbnail image, of the input frames, using a detected face feature and a determined characteristic, and a thumbnail image generation unit for generating one of the candidate frames meeting a set thumbnail image condition, as a thumbnail image.

The face feature may include at least one of a smile, a blink, a face size, and a face position.

The characteristic may include at least one of identity verification, sex, and age.

The candidate frame determination unit may calculate a parameter value according to the face feature and the characteristic, and store each of the candidate frames and a parameter value of the candidate frame.

The apparatus may further include a control unit that compares the parameter value of the candidate frame with the set thumbnail image condition value and controls the generation of a candidate frame corresponding to a parameter value meeting the thumbnail image condition value as a thumbnail image, as a result of the comparison.

The apparatus may further include a thumbnail condition setting unit that sets a thumbnail image condition including at least one of a smile condition, a blink condition, a face size, a face position, identity verification, sex, and age.

The thumbnail condition setting unit may give a different added value to each thumbnail image condition according to selection by a user.

The characteristic determination unit may determine a predetermined characteristic based on face recognition.

According to another aspect of the present invention, a digital imaging apparatus includes the apparatus for generating a thumbnail of a moving picture defined in the above apparatus.

The digital imaging apparatus may include a digital still camera or a digital camcorder.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a digital imaging apparatus according to an embodiment of the present invention;

FIG. 2 is a block diagram of a digital signal processing unit of FIG. 1;

FIG. 3 is a flowchart for explaining a method of generating a thumbnail of a moving picture according to another embodiment of the present invention;

FIG. 4 illustrates a conventional method of generating a thumbnail of a moving picture; and

FIG. 5 illustrates a method of generating a thumbnail of a moving picture according to another embodiment of the present invention.

### DETAILED DESCRIPTION OF THE EMBODIMENTS

The attached drawings for illustrating exemplary embodiments of the present invention are referred to in order to gain a sufficient understanding of the present invention, the merits thereof, and the objectives accomplished by the implementation of the present invention. Hereinafter, the present invention will be described in detail by explaining exemplary embodiments of the invention with reference to the attached drawings. Like reference numerals in the drawings denote like elements.

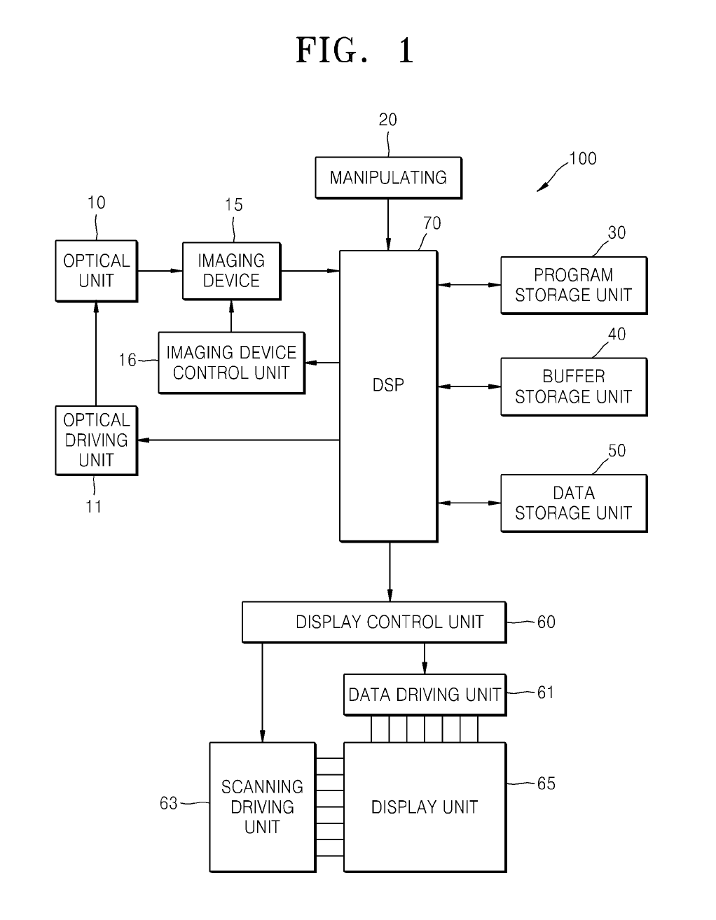

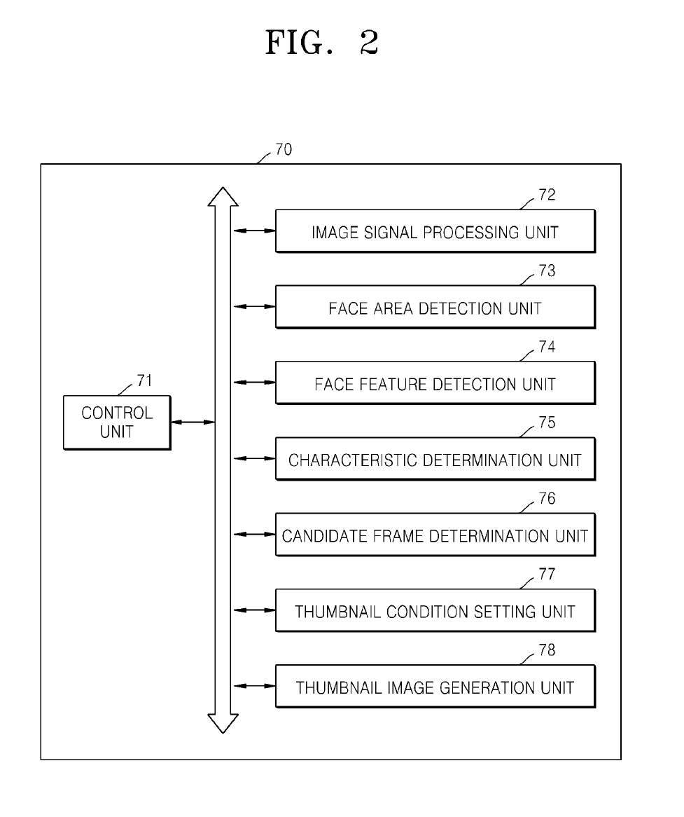

FIG. 1 is a block diagram of a digital imaging apparatus 100 according to an embodiment of the present invention. FIG. 2 is a block diagram of a digital signal processing unit (DSP) 70 of FIG. 1. The digital imaging apparatus 100 can take a moving picture of a high resolution and a moving picture of over 20 frames for seconds. The digital imaging apparatus 100 is not limited to a digital still camera including a compact digital camera or a digital single-lens reflex (DSLR) camera ant includes digital camcorders or all imaging apparatus capable of taking a moving picture.

Referring to FIG. 1, the digital imaging apparatus 100 includes an optical unit 10, an optical driving unit 11, an imaging device 15, an imaging device control unit 16, a manipulation unit 20, a program storage unit 30, a buffer storage unit 40, a data storage unit 50, a display control unit 60, a data driving unit 61, a scanning driving unit 63, a display unit 65, and the digital signal processing unit (DSP) 70.

The optical unit 10 receives an optical signal from an object for photography and provides the optical signal to the imaging device 15. The optical unit 10 may include at least one lens unit such as a zoom lens controlling a viewing angle to be wide or narrow according to a focal length and a focus lens focusing the object for photography. For example, a variety of moving pictures can be taken from a near distance to a far distance using an optical 5× zoom lens for taking a moving picture. Also, the optical unit 10 may further include an iris for adjusting the amount of light received by the imaging device 15.

The optical driving unit 11 controls the position of the lens or the opening/closing of the iris. The optical driving unit 11 can focus by moving the position of the lens and also control the amount of light by controlling the opening/closing of the iris. The optical driving unit 11 can control the optical unit 10 according to a control signal automatically generated by a moving picture signal that is input in real time or a control signal manually input by the operation of a user.

The optical signal transmitting the optical unit 10 forms an image of the object for photography on a light receiving surface of the imaging device 15. The imaging device 15 may be a charge coupled device (CCD) converting the optical signal to an electric signal or a complementary metal oxide semiconductor image sensor (CIS). The sensitivity of the imaging device 15 may be controlled by the imaging device control unit 16. The imaging device control unit 16 may control the imaging device 15 according to the control signal automatically generated by a moving picture signal that is input in real time or the control signal manually input by the operation of a user.

The manipulation unit 20 is for inputting a control signal externally input by a user, for example. The manipulation unit 20 includes a shutter-release button for inputting a shutter-release signal for taking a picture by exposing the imaging device 15 to light for a predetermined time, a power button for supplying power, a wide-zoom button and a tele-zoom button for increasing or decreasing a viewing angle according to an input, and a variety of function buttons for selecting a mode such as a text input mode, a photography mode, or a reproduction mode, a white balance setting function, and an exposure setting function. In the present embodiment, the user may take a moving picture by pressing a moving picture photography start/stop button provided in the manipulation unit 20. Also, the user may input conditions, for example, a face size, a position size, a smile condition, a blink condition, identity verification, sex, and age, regarding a desired thumbnail image of photographed moving picture data.

The manipulation unit 20 may have the above-described various buttons, but not limited thereto. The manipulation unit 20 may be embodied by any type of user input devices such as a keyboard, a touch pad, a touch screen and a remote controller.

Also, in the digital imaging apparatus 100, the program storage unit 30 stores a program such as an operating system program for operating the digital imaging apparatus 100 or an application system program. The buffer storage unit 40 temporarily stores data needed for operations or resultant moving picture data. The data storage unit 50 stores various information needed for a program, for example, a moving picture including an image signal.

In addition, in the digital imaging apparatus 100, the display control unit 60 controls the operation state of the digital imaging apparatus 100 or the display of a moving picture photographed by the digital imaging apparatus 100. The data driving unit 61 and the scanning driving unit 63 transmits display data output from the display control unit 60. The display unit 65 displays a predetermined moving picture according to a signal output from the data driving unit 61 and the scanning driving unit 63. The display unit 65 may be embodied by a liquid crystal display panel (LCD), an organic light emitting display panel (OLED), or an electrodeposition display (EPD) panel.

The digital imaging apparatus 100 includes the DSP 70 processing an input moving picture signal and controlling the respective constituent elements according to the input moving picture signal or an external input signal. The DSP 70 is described below with reference to FIG. 2.

Referring to FIG. 2, the DSP 70 includes a control unit 71, an image signal processing unit 72, a face area detection unit 73, a face feature detection unit 74, a characteristic determination unit 75, a candidate frame determination unit 76, a thumbnail condition setting unit 77, and a thumbnail image generation unit 78. The DSP 70 in the description can possibly be interpreted to be the same as a moving picture thumbnail generation unit used in the attached claims.

The control unit 71 controls an overall operation of the DSP 70. The image signal processing unit 72 converts a moving picture signal output from the imaging device 15 to a digital signal and performs image signal processing such as gamma correction, color filter array interpolation, color matrix, color correction, or color enhancement, to convert the moving picture signal to fit to an angle of view of a human. Also, the image signal processing unit 72, when a function thereof is set, may perform an auto white balance or auto exposure algorithm. Also, the image signal processing unit 72 adjusts the size of moving picture data using a scaler. For example, the image signal processing unit 72 forms a moving picture file in a predetermined format by compressing the moving picture data using an MPEG-4 compression method, or decompresses the moving picture file. The image signal processing unit 72 may perform the above image signal processing to a moving picture signal input in response to a moving picture signal and a shutter-release signal input in real time in a live-view mode prior to photography. In doing so, different image signal processing may be performed to each of the image signals.

The face area detection unit 73 detects a face area from the input frames input in real time through the moving picture photography. The input frames may be images processed by the image signal processing unit 72 and a face area is detected from the image processed input frames. The detection of a face area means the detection of a position and/or size in an input frame image. The face area detection unit 73 detects a face area by comparing the input image data with face feature data that is previously memorized and recognizing whether the face feature data exists in the input image. There are many conventional technologies about the face area detection and the face area may be detected using an Adaboosting algorithm or skin color information.

The face feature detection unit 74 detects the features of a face from the face areas in each of the frames detected by the face area detection unit 73. The face features include a smile, a blink, a face size, and a position size. Active appearance models (AAM) or active shape models (ASM) may be used for the detection of the face. The ASM is a model for detecting the position of an eye and determining the position of other portions of the face using information on the shape of other portions, for example, nose, mouth, or eyebrow, according to a generic model based on the detected eye position. The AAM is a model for detecting feature points that can efficiently describe the face feature in consideration of texture information. For example, eight features points of two eyebrows, two eyes, one nose, two side ends of a lip, and one upper lip can be detected using the AAM. Accordingly, not only a smile or a blink, but also the size and position of a face, may be detected through the detection of the face features. Although in the present embodiment the AAM and the ASM are mainly described, the present invention is not limited thereto and any detection algorithm may be used for the determination of a smile or a blink.

The characteristic determination unit 75 determines a predetermined characteristic based on the detected face areas. The characteristic includes my face or others' face, sex, and age. The characteristic is determined based on the face recognition of the detected face. In the general face recognition, whether the detected face is a specific person's face or not may be determined by comparing the feature vectors extracted from the detected face areas with the feature vectors of a face to be recognized, for example, a face stored in a specific person's face database. A variety of conventional technologies may be used in relation to the face recognition. The features, that is, sex or age, may be determined based on the face recognition.

The candidate frame determination unit 76 determines candidate frames to generate a thumbnail image among the input frames using the face feature detected by the face feature detection unit 74 and the characteristic determined by the characteristic determination unit 75. For example, when a face area is detected in the 10^{th} frame through the 20^{th} frame photographed for one second, eleven frames from the 10^{th} frame to the 20^{th} frame (inclusive) are determined as candidate frames. Also, the candidate frame determination unit 76 stores parameter values of the face features and characteristics appearing at each input frame with the frame number. That is, the parameter values are given to the face feature detected and the characteristic determined from each candidate frame and stored with the frame number.

The thumbnail condition setting unit 77 gives a different added value to each thumbnail image condition according to the selection of a user. The thumbnail image condition includes a face size, a position size, a smile condition, a blink condition, an identity verification, sex, and age. Thus, the user may obtain a desired thumbnail image while taking a moving picture. For example, if the user wants to store one's smiling face as a thumbnail image, an added value is given to the smile and identity verification so that a frame image having one's smiling face may be stored as a thumbnail image.

The control unit 71 compares the parameter value of the candidate frame determined by the candidate frame determination unit 76 with a thumbnail image condition value set through the thumbnail condition setting unit 77. As a result of the comparison, the control unit 71 controls the thumbnail image generation unit 78 to generate a candidate frame corresponding to the parameter value matching or most similar to the thumbnail image condition value, as a thumbnail image.

The thumbnail image generation unit 78 generates one of the candidate frames corresponding to the set thumbnail image condition value as a thumbnail image. A small thumbnail image is generated by down sampling an image of a particular frame of moving picture data.

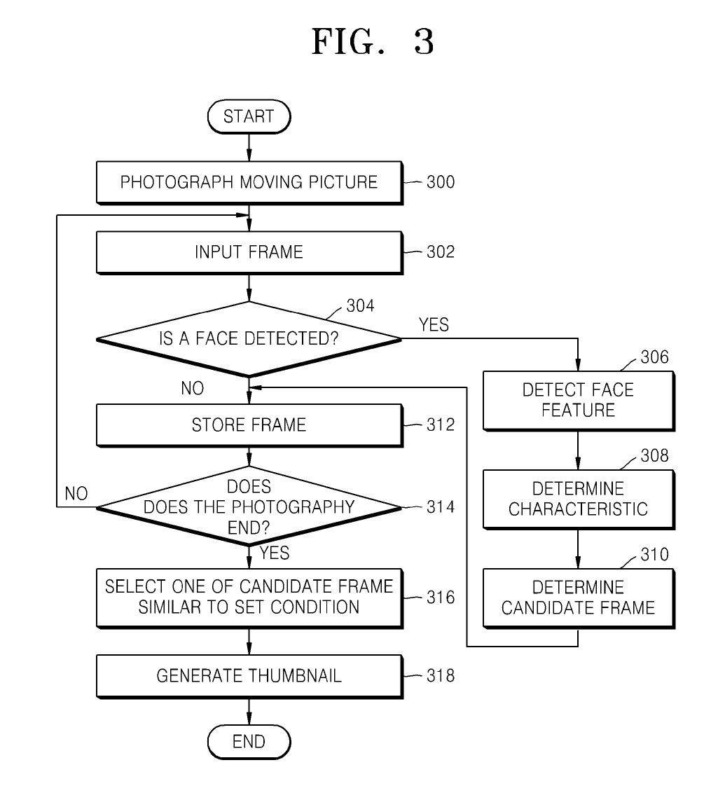

FIG. 3 is a flowchart for explaining a method of generating a thumbnail of a moving picture according to another embodiment of the present invention. Referring to FIG. 3, in Operation 300, moving picture recording is started as a user presses the moving picture recording start button. In Operation 302, frames are sequentially input. In Operation 304, a face area is detected from the frames that are sequentially input. When the face area is detected in Operation 304, a face feature is detected in Operation 306 and a face characteristic is determined in Operation 308. The face feature includes a face size, a position size, smile, and blink while the face characteristic includes identity verification, sex, and age. Although in the present embodiment the face feature and characteristic are described, the present invention is not limited thereto and any face features and characteristics may be included. Also, Operations 306 and 308 may be performed simultaneously or opposite of their order as indicated in FIG. 3.

In Operation 310, a candidate frame is determined based on the detected face feature and the determined face characteristic. In Operation 312, a parameter value about the face feature and characteristic is stored with the candidate frame. When the face area is not detected from the input frame in Operation 304, the frame is stored in Operation 312.

In Operation 314, it is determined whether the moving picture recording ends as the user presses the moving picture recording stop button. In Operation 314, the photography ends. In Operation 316, a candidate frame in which the parameter value of the candidate frame stored in Operation 314 matches, or is most similar to, a set condition value is selected. The set condition value may be a value set by the user or a condition value set as default. In Operation 318, the selected candidate frame is generated as a thumbnail image.

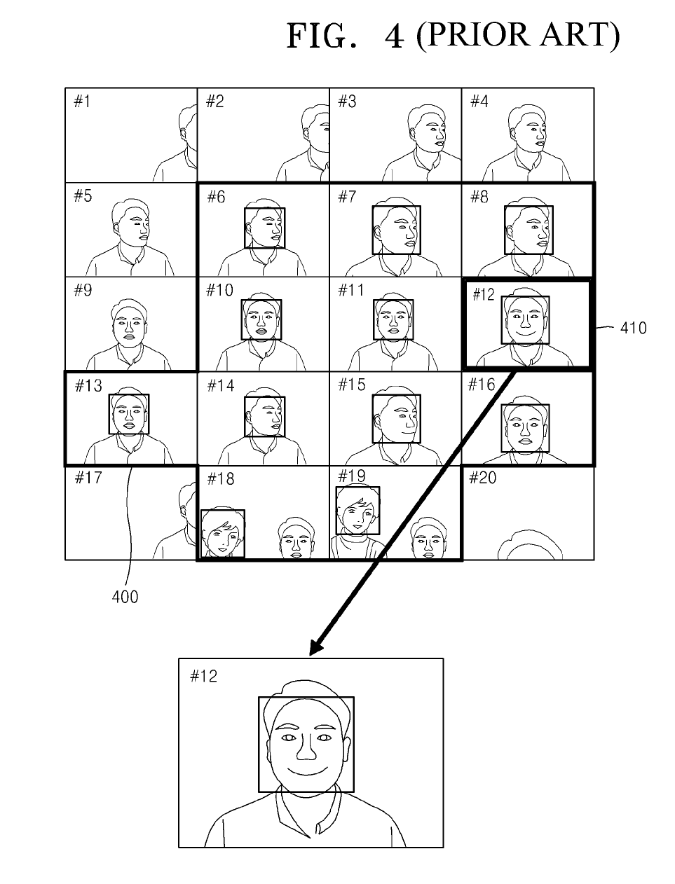

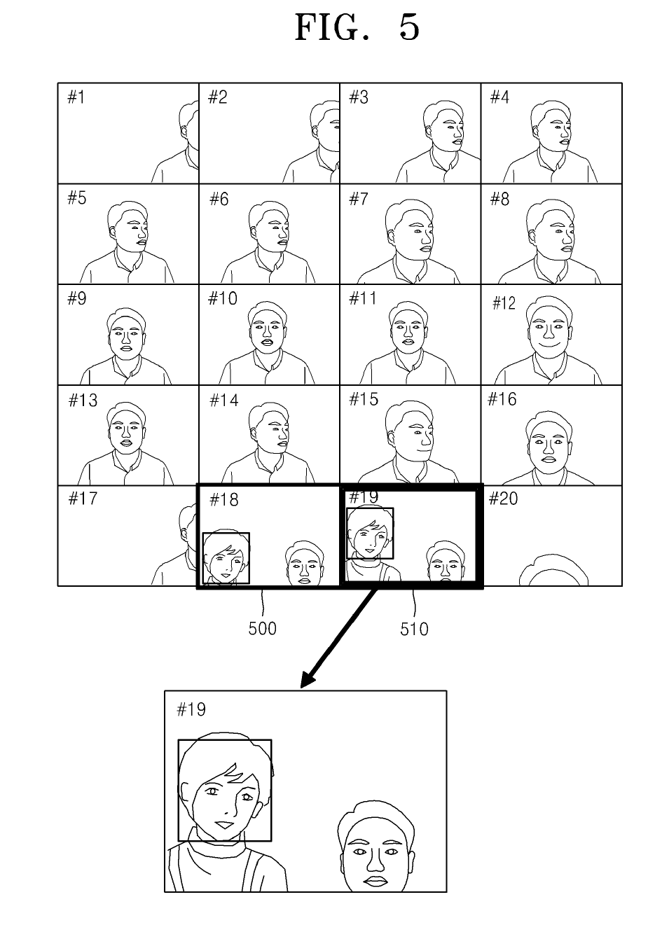

FIG. 4 illustrates a conventional method of generating a thumbnail of a moving picture. FIG. 5 illustrates a method of generating a thumbnail of a moving picture according to another embodiment of the present invention. FIGS. 4 and 5 illustrate the comparison between the convention method and the method according to another embodiment of the present invention. FIG. 4 illustrates how a thumbnail image is selected from twenty photographed frame images according to the conventional technology.

Referring to FIG. 4, the moving picture thumbnail generation is determined with face detection, a face position, and a face size only. Thus, the 6^{th} to 16^{th} frames, in which a face is detected, and the 18^{th} and 19^{th} frames, in which the face is detected again, are selected as candidate frames 400. The 12^{th} frame 410 in which the face position is center and the face size is the largest is selected as a frame for the final thumbnail generation. However, the selected frame is not a result desired by the user because the face of the selected frame is not the face of the user. That is, since the thumbnail is selected, as face detection based candidate group, with the face size and the face position only, a thumbnail of other person's face may be finally selected.

FIG. 5 illustrates how a thumbnail image is generated for 20 frames of the same moving picture. Referring to FIG. 5, the conditions for the thumbnail generation are face detection, a face position, a face size, a smile detection, a blink detection, and identity verification. In this case, the 18^{th} and 19^{th} frames of the 20 frames are the thumbnail candidate frames. That is, although the 1^{st} through 17^{th} and 20^{th} frames meet the conditions of the face detection and the face size, since these frames do not include the face of the user, the frames are not determined as candidate frames. Thus, of the 18^{th} and 19^{th} frames, the 19^{th} frame in which the face of the user is detected and the conditions of the smile, the blink, the face position, and the face size are met is finally selected as a candidate frame for the thumbnail generation. Thus, the 19^{th} frame including the face of the user is generated as a thumbnail image, which is a result desired by the user.

Thus, according to the present embodiment, a thumbnail of a moving picture is generated by selecting a candidate group of frames based on the persons appearing on the moving picture using face detection, a smile detection, and a blink detection, and determining the best frame for oneself from the candidate group.

As described above, in the method of generating a thumbnail of a moving picture according to the present invention, a face area is detected from input frames, candidate frames for generating a thumbnail image is determined among the input frames by means of the face feature detection and characteristic determination, and one of the candidate frames that meets the set thumbnail image condition is generated as a thumbnail image. Thus, a thumbnail image desired by a user can be obtained.

Also, by determining various candidates considering a face, a face size, a position size, presence of a smile, presence of a blink, identity verification, sex, and age, the best scene or a preset scene is stored as a thumbnail so that a moving picture identification capability during reproduction of the moving picture can be better selected.

Although the above-described embodiments describe a digital camera as an example of the digital imaging apparatus, the present invention is not limited thereto. One skilled in the art may understands that the present invention can be applied to a digital camcorder, a camera phone with a camera function, a personal digital assistant (PDA), and a portable multimedia player (PDA).

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

The system or systems described herein may be implemented on any form of computer or computers and the components may be implemented as dedicated applications or in client-server architectures, including a web-based architecture, and can include functional programs, codes, and code segments. Any of the computers may comprise a processor, a memory for storing program data and executing it, a permanent storage such as a disk drive, a communications port for handling communications with external devices, and user interface devices, including a display, keyboard, mouse, etc. When software modules are involved, these software modules may be stored as program instructions or computer readable codes executable on the processor on a computer-readable media. The computer readable recording medium can also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the present invention.

What is claimed is:

1. A method of generating a thumbnail of a moving picture, the method comprising:
detecting face areas from input frames;
detecting a face feature from each of the input frames based on a detected face area;
determining a predetermined characteristic based on the face area;
determining candidate frames for generating a thumbnail image, of the input frames, using the detected face feature and the predetermined characteristic; and
generating one of the candidate frames meeting a set thumbnail image condition, as a thumbnail image.

2. The method of claim 1, wherein the face feature comprises at least one of a smile, a blink, a face size, and a face position.

3. The method of claim 2, wherein the characteristic comprises at least one of identity verification, sex, and age.

4. The method of claim 3, wherein, in the determining of candidate frames, a parameter value according to the face feature and the characteristic is calculated and each of the candidate frames and a parameter value of the candidate frame are stored.

5. The method of claim 4, further comprising:
comparing the parameter value of the candidate frame with the set thumbnail image condition value; and
controlling the generation of a candidate frame corresponding to a parameter value meeting the thumbnail image condition value as a thumbnail image, as a result of the comparison.

6. The method of claim 3, further comprising setting a thumbnail image condition including at least one of smile, blink, a face size, a face position, identity verification, sex, and age.

7. The method of claim 6, wherein a different added value is given to each thumbnail image condition according to selection by a user.

8. The method of claim 5, further comprising, before the comparing of the parameter value of the candidate frame with the set thumbnail image condition value:
ending the photography of a moving picture according to selection by a user.

9. The method of claim 3, wherein the determining of a predetermined characteristic based on the face area is based on face recognition.

10. A computer readable recording medium having recorded thereon computer readable program code embodied therein for executing a of generating a thumbnail of a moving picture, the method comprising:
detecting face areas from input frames;
detecting a face feature from each of the input frames based on a detected face area;
determining a predetermined characteristic based on the face area;
determining candidate frames for generating a thumbnail image, of the input frames, using the detected face feature and the predetermined characteristic; and
generating one of the candidate frames meeting a set thumbnail image condition, as a thumbnail image.

11. An apparatus for generating a thumbnail of a moving picture, the apparatus comprising:
a face area detection unit for detecting a face area from input frames;
a face feature detection unit for detecting a face feature from each of the input frames based on a detected face area;
a characteristic determination unit for determining a predetermined characteristic based on the face area;
a candidate frame determination unit for determining candidate frames for generating a thumbnail image of the input frames, using a detected face feature and a determined characteristic; and
a thumbnail image generation unit for generating one of the candidate frames meeting a set thumbnail image condition, as a thumbnail image.

12. The apparatus of claim 11, wherein the face feature comprises at least one of smile, blink, a face size, and a face position.

13. The apparatus of claim 12, wherein the characteristic comprises at least one of identity verification, sex, and age.

14. The apparatus of claim 13, wherein the candidate frame determination unit calculates a parameter value according to the face feature and the characteristic, and stores each of the candidate frames and a parameter value of the candidate frame.

15. The apparatus of claim 14, further comprising a control unit for comparing the parameter value of the candidate frame with the set thumbnail image condition value and controlling the generation of a candidate frame corresponding to a parameter value meeting the thumbnail image condition value as a thumbnail image as a result of the comparison.

16. The apparatus of claim 13, further comprising a thumbnail condition setting unit that sets a thumbnail image condition including at least one of a smile condition, a blink condition, a face size, a face position, identity verification, sex, and age.

17. The apparatus of claim 16, wherein the thumbnail condition setting unit allocates a different added value to each thumbnail image condition according to a selection by a user.

18. The apparatus of claim 13, wherein the characteristic determination unit determines a predetermined characteristic based on face recognition.

19. A digital imaging apparatus comprising the apparatus for generating a thumbnail of a moving picture according to claim 11.

20. The digital imaging apparatus of claim 19, comprising a digital still camera or a digital camcorder.
